(19) United States
(12) Patent Application Publication
(10) Pub. No.: US 2009/0186119 A1
(43) Pub. Date: Jul. 23, 2009

(54) Food composition

(75) Inventors: Richard Draijer, Vlaardingen (NL); Sandra den Hartog, Vlaardingen (NL); Theodorus Pierre Jacques Mulder, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a Unilever

(21) Appl. No.: 12/321,069

(22) Filed: Jan. 15, 2009

(30) Foreign Application Priority Data
Jan. 17, 2008 (EP) EP08150339

(51) Int. Cl. A23C 11/10; A23L 2/02; B65D 85/72; A23J 1/14

(52) U.S. Cl. 426/2; 426/598; 426/599; 426/106

(57) ABSTRACT

A liquid food product comprising 0.1 to 1.5 wt % of polyphenols, wherein said polyphenols contain a mixture of polyphenols from red grape and polyphenols from red wine in a weight ratio of from 1:1 to 1:5, closed container comprising 50 to 250 ml of the liquid food product and use of the liquid food product for reducing blood pressure.

### FIELD OF THE INVENTION

The invention relates to a food composition, specifically to a functional food composition having one or more health effects in humans. In particular, such health effect is related to a decreased risk of cardiovascular disorders.

### BACKGROUND TO THE INVENTION

Polyphenolic compounds (hereinafter polyphenols) enjoy a considerable scientific interest for their health promoting properties. Epidemiological studies have shown that consumption of foods rich in polyphenols is associated with a lower incidence of cardiovascular disorders.

Since polyphenols are widespread among plants and plant products, polypherfols are naturally present in many foods including fruits, vegetables and fruit drinks, in varying amounts.

A number of studies in the prior art were directed to red grape products, such as red grape juice and red wine.

Well-known is the so-called ‘French paradox’. The paradox is the low cardiovascular mortality rate observed in Mediterranean populations in association with red wine consumption despite a high saturated fat intake.

Effects of grape products on various cardiovascular health markers, including blood pressure, platelet function and plasma lipid profiles, have been evaluated in a number of human trials, see for example the overview as given in WO2005/122793.

For the application in functional food products, grape juice and red wine are less suitable, since in juice and wine the concentration of polyphenols is relatively low. Also, when juice or red wine are added to a functional food composition, there may be product components introduced into the food that are not desirable, such as alcohol and sugar.

Dozens of different grape and wine extracts are commercially available, the extracts include grape extract, wine extract, skin- and/or seed extract. However most of these extracts are not suitable for application in a functional food, since they are not efficacious or have a bad taste.

EP-B-930831 describes a plant-derived flavonol-containing dry composition obtained from grapes, wine or flavonol-containing by-products or waste-products of wine making having a high polyphenol content, preferably at least-45% polyphenols. The dry composition is suitable for reducing the risk of cardiovascular disease. In particular, the composition has the effect of inhibiting oxidation of plasma LDL, stimulation of TGF-β production, inhibiting platelet aggregation and stimulating fibrinolysis. The dry composition is used as a medicament or as food supplement.

FR 2772235 describes polyphenol compositions comprising a concentrated grape juice (comprising 1-20 wt % of polyphenols), wine extract (comprising 1-20 wt % of polyphenols) and a hydrosoluble olive extract comprising 0.5 to 40 wt % of polyphenols.

WO2005/122793 discloses a fruit juice product comprising a combination of grape juice extract and wine extract.

Anonymous: “Boisson au soja enrichi en calcium, XP002471959 retrieved from the internet 2008-03-07 discloses a soy product comprising grape-seed extract in an undisclosed amount.

A problem with the addition of polyphenols to food products is that often the taste of the product is negatively affected. On the other hand food products containing polyphenols may negatively interact with the bioavailability of the polyphenol ingredients, therewith reducing its effectiveness as a health promoting food product.

It is therefore an object of the present invention to provide a food product which can easily be dosed in adequate amounts, wherein the food product comprises polyphenol components and wherein the type of food and the type and amount of polyphenols is chosen such that good food product quality can be obtained while ensuring a good bioavailability of the polyphenol compounds and which is adequately efficacious in decreasing risk of cardiovascular disorders, specifically reduction of hypertension, inhibition of platelet aggregation, reduction of level of total blood cholesterol and/or reduction of level of LDL cholesterol.

It is a further object of the present invention to provide a useful alternative polyphenol comprising food product.

One or more of these objects are attained according to the invention in a food composition as described below.

In a first aspect the invention relates to a liquid food product comprising 0.1 to 1.5 wt % of polyphenols, wherein said polyphenols contain a mixture of polyphenols from red grape and polyphenols from red wine in a weight ratio of from 1:1 to 1: 5, said food product comprising 0.1 to 5 wt % of soyprotein.

Surprisingly it has been found that a combination of red grape and red wine polyphenols, preferably on relatively high amounts, in liquid food products comprising 0.1 to 5 wt % of soy protein provides food products with good polyphenol bioavailability which can easily be dosed.

Advantageously the product comprises 0.2 to 1.4 wt %, preferably 0.4 to 1.2 wt % and , more preferably 0.6- 1.0 wt % of polyphenols which are a combination of polyphenols from red grape juice and polyphenols from red wine in a polyphenol weight ratio of from 1:1 to 1:5, more preferred from 1:1.5 to 1:3, most preferred from 1:1.8 to 1:2.5, based on the values obtained from the Folin-Ciocalteu method.

### DETAILED DESCRIPTION OF THE INVENTION

Compositions of the invention are liquid food products. For the purpose of the invention liquid food products are fluid products with a relatively low viscosity, which can readily be poured and which can easily be consumed as a drink. Such products can easily be manufactured, packed and dosed to consumers. Preferred liquid food products of the invention are packed in closed containers comprising single dose portions of 50 to 250 ml, for example from 75 to 125 ml. Preferably single dose portions are separately packed in closed containers e.g. bottles to ensure reliable dosing of ingredients while maintaining optimal freshness of the product. Advantageously the total amount of polyphenols per single dose portion is from 100 to 1500 mg, more preferred from 400 to 1300 mg, especially preferably from 600 to 1000 mg.

The liquid products of the invention comprise from 0.1% to 5 wt % of soy protein more preferably from 0.5 to 4 wt %, for example from 2.5 to 4.5 wt %, more general from 3.0 to 4.0 wt %. These levels can readily be obtained by using a soy-based drink as the basis for the liquid food product of the invention. Typically a soy-based drink is readily available e.g. containing about 3.5 wt % of soy protein. The level of soy-based drink in the liquid product preferably is from 75 to 99.9%, more preferred from 80 to 95 wt %. Alternatively the liquid products of the invention comprise a fruit juice base whereto soy protein has been added, for example orange juice or apple juice with soy protein. Such fruit juice base, which can for example be a mixture of concentrated juice and water or can be undiluted fruit juice, is advantageously present in amounts from 75 to 99.9%, more preferred from 80 to 95 wt % wherein these amounts are calculated as if undiluted, non-concentrated fruit juice is used.

Liquid products of the invention preferably comprise from 0.2-1.4 wt % of polyphenols, more preferred from 0.4 to 1.2 wt %, more preferred from 0.6 to 1.0 wt %. For this purpose the polyphenol content can for example be determined by measuring the gallic acid equivalent value as illustrated in the examples, but other suitable methods e.g. via spectroscopy are readily available.

In a preferred embodiment, the liquid food products of the invention are substantially free from the milk protein casein. For the purpose of the invention this means that the amount of casein from dairy sources such as dairy bovine milk protein is zero or less than 1 wt %, more preferred less than 0.5 wt %, especially 0.1 wt % or lower. More preferred the liquid food products of the invention are substantially free from milk protein. These low levels of milk proteins ensure that minimum interference between the polyphenols and the milk protein, therewith optimizing the bioavailability of the polyphenols.

Preferably at least part of the polyphenols originates from a red wine extract having a high polyphenol content. Examples of preferred red wine extracts that are commercially available, are given in table 1.

TABLE 1
Preferred, commercially available wine extracts

| | | Polyphenol |
|---|---|---|
| | | content |
| | | according to |
| Name of wine extract | Name supplier | supplier (w/w) |
| Provinols | Seppic, France | 95% |
| Meganatural red wine | Polyphenolics, USA | 25% |
| concentrate extract | | |

Preferably at least part of the polyphenols originates from a red grape juice extract having a high polyphenol content. Examples of preferred red grape juice extracts, that are commercially available, are given in table 2.

TABLE 2
Preferred, commercially available red grape juice extracts

| | | Polyphenol |
|---|---|---|
| | | content |
| | | according to |
| Name grape extract | Name supplier | supplier (w/w) |
| Meganatural Rubired | Polyphenolics, USA | 45% |
| grape juice extract | | |
| Grape'Active Red H | Ferco Nutraceutique | 80% |
| | France | |
| Traubenpolyphenol | Breko, Germany | 80% |
| pulver | | |
| Red grape polyphenol | Breko, Germany | 80% |
| powder | | |
| Polyphenols from | La Gardonnenque | 92% |
| grape | SCA, France | |

The food composition according to the invention may preferably be used as a physiologically functional food product. According to a preferred embodiment, the consumption of the food composition by a human subject is effective in causing in the human subject one or more, preferably two or more, more preferably three or more and most preferably all four of the following effects:

a) reduction of hypertension;

b) inhibition of platelet aggregation;

c) reduction of level of total blood cholesterol;

d) reduction of level of LDL cholesterol.

The liquid food products according to the invention may comprise common food ingredients in addition to the polyphenols, such as water, flavour, sugar, fruits, minerals, vitamins, stabilisers, thickeners, starches etc. in appropriate amounts. Preferably the liquid food products are soy-based products or fruit juice based products.

The liquid food product of the invention can advantageously be used as a dietary component especially for consumers with a wish to decrease cardiovascular risk, such as high cholesterol levels or increased blood pressure. Especially advantageously the food product is for use to lower blood pressure.

The dosing of the food product preferably is such that a daily dosage contains 600 to 1200 mg, especially 700 to 1000 mg of polyphenols. Especially the daily dosage is administered in a single dose from a closed container comprising 600 to 1200 mg, particularly 700 to 1000 mg of polyphenols. Especially preferable the intake of the daily dose is part of a meal. More preferably the daily dosage is consumed as part of a main meal, particularly breakfast, wherein preferably the overall intake of milk protein during said meal is less than 5 g, more preferred from 0 to 3 g.

### EXAMPLES

Determination of Polyphenol Content

Total polyphenol content can be measured using Folin-Ciocalteau colour reagent at mildly basic pH in an UV-spectroscopic method. Quantification can be achieved by determining the total polyphenol content as Gallic Acid Equivalents (GAE) or epicatechin equivalents (ECE), using standard curves for gallic acid and epicatechin.

### Example 1

Polyphenol containing products were tested as follows:

Thirty-five apparently healthy males age between 18 and 70 years and a Body Mass Index between 19 and 30 kg/m² took part in the present study.

Time Schedule of human trial

The trial consisted of 5 consecutive treatment periods which were identical except for the test product consumed. Five treatments using products A to E as described below were subsequently tested in a randomised order according to the following schedule.

Day 1 to 4: subjects consumed the test product during breakfast.

Day 5: subjects consumed test product at the test facility in a fasted state.

Starting on day 2 in the evening and up to and including day 5 after the last blood sample was collected the subjects were on a low polyphenol diet including restrictions on alcohol and fish consumption.

During breakfast no milk products were consumed.

Blood was collected on day 5 before consumption of the test product and after 1, 2 and 3 hours.

Urine was collected starting on day 4 after breakfast for 24 hours.

A wash out period was observed on days 6 and 7.

After the wash out period a new product was tested.

After the fifth treatment period no wash out period was observed.

The measurements consisted of 24 hours urine collection, whereby the hippuric acid content in the total urine is determined. Urinary hippuric acid is believed to be a good marker to measure the bioavailability of polyphenols and its metabolites in the human body, whereby an increased hippuric acid content is believed to co-incide with a lowering of the blood pressure.

Treatments A-E

Treatment A (positive control): daily dosis of gelatine capsules containing 550 mg red wine polyphenols (source provinols, ex Seppic) and 250 mg of red grape polyphenols (source Meganatural, Rubired grape extract ex Polyphenolics). The daily dose was administered with 200 ml water as part of a breakfast and the last dose in a fasted state.

Treatment B (dosing of polyphenols in a dairy base): 550 mg red wine polyphenols and 250 mg of red grape polyphenols (as above) were added to 200 ml of yoghurt in a closed container containing 1.4 wt % of fat, 3.4% of milk protein and 0.7 wt % lactic acid. The daily dose was administered as part of a breakfast and the last dose in a fasted state.

Treatment C (dosing of polyphenols in a soy-based drink base): 550 mg red wine polyphenols and 250 mg of red grape polyphenols as above were added to 200 ml of a soy-based drink, with a protein content of 3.4% and a fat level of 2 wt %. the daily dosis was administered as part of a breakfast and the last dose in a fasted state.

Treatment D (dosing of polyphenols in a orange juice base): 550 mg red wine polyphenols and 250 mg of red grape polyphenols as above were added to 200ml of a juice with a carbohydrate content of 4 wt % which is substantially protein free. The daily dose was administered as part of a breakfast and the last dose in a fasted state.

Treatment E (placebo) empty gelatine capsules containing no red wine polyphenols and no grape juice polyphenols. Administered as part of breakfast and the last dose in a fasted state.

The following results were obtained

Treatment E lead to a base line hippuric acid content in urine collected over 24 hours of 0.89 g.

Treatment A lead to a hippuric acid content of 1.27 g amounting to an increase in the hippuric acid content (compared to the placebo) of 0.38 g/24 h.

Treatment B lead to a hippuric acid content of 1.14 amounting to an increase in hippuric acid content compared to the placebo of 0.25 g/24 h. Overall the increase of hippuric acid in Treatment B compared to the placebo was 34% less than the increase while using Treatment A.

Treatment C lead to a hippuric acid content of 1.26 g amounting to an increase in the hippuric acid content (compared to the placebo) of 0.37 g/24 h. This is a similar increase in hippuric acid as treatment A, showing that soy is an excellent vehicle for the dosage of these polyphenolic compounds. Treatment D lead to a hippuric acid content of 1.19 g. Amounting to an increase in hippuric acid (compared to the placebo) of 0.30. Overall the increase in hippuric acid content in treatment D compared to the placebo was 21% less than the increase while using treatment A.

Summary of Results

Increase in hippuric acid content compared to placebo (g/24 h)

| | |
|---|---|
| A | 0.38 |
| B | 0.25 |
| C | 0.37 |
| D | 0.30 |
| E | — |

These results show the following:
The use of relatively high levels of polyphenols provide an increase in hippuric acid content for all liquid food bases.
A weight ratio of 1:2.2 of red grape to red wine polyphenols provided in a liquid food provide significant increases in hippuric acid content compared to the placebo.
The presence of soy protein unexpectedly does not negatively impact the hippuric acid content in the urine.
The presence of dairy protein leads to a considerable lowering of the hippuric acid content compared to the soy base and the positive control.
The use of a liquid juice as the base for administering polyphenols leads to a reduction of hippuric acid content compared to the soy base and the positive control. However, surprisingly the use of a liquid juice in combination with relatively high levels of polyhenols wherein the weight ratio of red grape polyphenols to red wine polyphenols is 1:2.2 still provides an adequately high increase of hippuric acid levels in the blood, as maybe deduced from the high urinary hippuric acid content.

In this context it is submitted that an increase of hippuric acid content of 0.25 g or more (24 h/urine as compared to placebo) is an increase sufficient to have an impact on the blood pressure of the consumer.

1. A liquid food product comprising 0.1 to 1.5 wt % of polyphenols, wherein said polyphenols contain a mixture of polyphenols from red grape and polyphenols from red wine in a weight ratio of from 1:1 to 1:5 and 0.1 to 5 wt % of soy protein.

2. Liquid food product according to claim 1, comprising 0.2 to 1.4 wt %, preferably 0.4 to 1.2 wt % and more preferably 0.6 to 1.0 wt % of said polyphenols.

3. Liquid food product according to claim 1, wherein the polyphenols contain polyphenols from red grape and polyphenols from red wine in a weight ratio of from 1:1 to 1:3.

4. Liquid food product according to claim 1 comprising 0.1 to 5 wt % of soy protein.

5. Liquid food product according to claim 1 comprising 75 to 99.9 wt % of fruit juice.

6. Liquid food product according to claim 1 comprising no or less than 1 wt % of casein, preferably comprising no or less than 1 wt % of milk protein.

7. Liquid food product according to claim 1 packed in closed container comprising 50 to 250 ml of the liquid food product.

8. Liquid food product according to claim 7, wherein the closed container comprises 75 to 125 ml of the liquid food product.

9. Closed container according to claim 7 comprising 100 to 1500 mg, preferably 400 to 1300 mg and even more preferably 800 to 1100 mg of polyphenols.

10. Use of the liquid food product according to claim 1 for reducing blood pressure.

11. Use according to claim 10, wherein the use involves the daily consumption of a single dose in accordance to claim 9.

12. Use according to claim 11, wherein the consumption takes place as part of a meal, preferably breakfast.

13. Use according to claim 12, wherein said meal provides an overall intake of less than 5 gram, more preferred 0 to 3 gram of milk protein.
